(19) United States
(12) Patent Application Publication
(10) Pub. No.: US 2015/0049488 A1
(43) Pub. Date: Feb. 19, 2015

(54) ILLUMINATION ASSEMBLY

(71) Applicant: Baoliang Wang, Baldwin Park, CA (US)

(72) Inventor: Baoliang Wang, Baldwin Park, CA (US)

(21) Appl. No.: 13/965,268

(22) Filed: Aug. 13, 2013

(51) Int. Cl. F21V 5/04; F21V 29/00

(52) U.S. Cl. CPC F21V 5/048; F21V 29/22
USPC 362/294; 362/311.09

(57) ABSTRACT

An illumination assembly for creating an illumination display by manipulating the angle of an electromagnetic radiation, such as visible light. The assembly includes variously configured lenses that at least partially deviate the direction of an electromagnetic radiation from an illumination portion. A housing contains an illumination portion and lenses. The housing portion further includes a thermal absorbing portion for absorbing heat generated by the illumination portion. A sealing portion helps inhibit moisture from entering the housing. The illumination portion includes a flexible light emitting diode strip. A diverging lens broadens the electromagnetic radiation. A converging lens focuses the electromagnetic radiation. A flat lens allows the electromagnetic radiation to remain in a substantially straight angle. The illumination portion and each lens can be oriented at various angles.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to directional illumination. More particularly, the invention relates to variously configured lenses that reflect electromagnetic radiations into convergence, divergence, and flat illuminations.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that A light-emitting diode is a semiconductor light source. Light emitting diodes are used as indicator lamps in many devices and are increasingly used for other lighting.

Typically, when a light-emitting diode is switched on, electrons are able to recombine with holes within the device, releasing energy in the form of photons. This effect is called electroluminescence and the color of the light is determined by the energy band gap of the semiconductor.

Often, a lens is an optical device which transmits and refracts light, converging or diverging the beam. A concave lens is a lens with inward-curving surfaces. A convex lens is a lens with outwardly-curving surfaces.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrates various views of an exemplary illumination assembly with a flat lens, where FIG. 1A illustrates of a top view, and FIG. 1B illustrates a side view, in accordance with an embodiment of the present invention;

FIGS. 2A and 2B illustrates various views of an exemplary illumination assembly with a converging lens, where FIG. 2A illustrates of a top view, and FIG. 2B illustrates a side view, in accordance with an embodiment of the present invention;

FIGS. 3A and 3B illustrates various views of exemplary lenses, where FIG. 3A illustrates of a converging lens, and FIG. 3B illustrates a diverging view, in accordance with an embodiment of the present invention; and

FIGS. 4A and 4B illustrates various views of an exemplary illumination assembly with a flat lens, where FIG. 1A illustrates of a top view of a series of illumination assemblies, and FIG. 1B illustrates a side view of a series of illumination assemblies, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of directional illumination assemblies that may be provided by preferred embodiments of the present invention. In one embodiment of the present invention, an illumination assembly may provide variously configured lenses that at least partially deviate the direction of electromagnetic radiations from an illumination portion. The illumination portion may include a light emitting diode for projecting a visible ray of light through the lenses. The lenses may allow the electromagnetic radiation to pass through, converge, diverge, and/or remain at a substantially linear angle. In this manner, various optical illusions may be generated through the different angles of electromagnetic radiations. The resulting illumination may project a large viewing angle, a concentrated narrow beam, and a regular viewing beam. The lenses may also have a sealant that serves to help inhibit moisture and contaminants from engaging the illumination portion. In some embodiments, the assembly may reside in a housing having properties efficacious for absorbing and dispersing thermal energy generated by the illumination portion. The housing may further include moisture proof components to protect the illumination portion from external moisture and contaminants.

In one embodiment of the present invention, the lenses may include at least one diverging lens that broadens, or diverges the electromagnetic radiation from the illumination portion. Additionally, the lenses may include at least one converging lens that focuses, or converges the electromagnetic radiation from the illumination portion. Further, the lenses may include at least one flat lens that allows the electromagnetic radiation to pass through at a substantially straight angle. Each lens may be adjustably angled to orient in a desired direction, whereby myriad combinations of illumination direction, color, intensity, convergence, and divergence may be projected. In some embodiments, the illumination portion may include a light emitting diode. Those skilled in the art, in light of the present teachings, will recognize that light emitting diodes generate a considerable amount of heat. The heat may require dissipation so as not to damage the assembly or the lenses.

In one embodiment, a housing may protect, receive, and position the light emitting diode and the lenses. The light emitting diodes may be disposed to orient in a coplanar orientation with the lenses, whereby each lens allows electromagnetic radiations to pass through from an individual light emitting diode. In some embodiments, the housing may include a thermal dispersion portion, such as a heat sink, that may be efficacious for dissipating and absorbing the heat generated by the light emitting diodes. The thermal absorbing portion may comprise an aluminum material that engages the illumination portion for enhanced dispersion and absorbing of the thermal energy. In some embodiments, a sealing portion may be integrally disposed with the thermal absorbing portion to create a moisture proof seal. The sealing portion may include a polyamide melt. In some embodiments, a circuitry may regulate the actuation of the illumination portion and dispersion of thermal energy. A power source may provide power to the assembly.

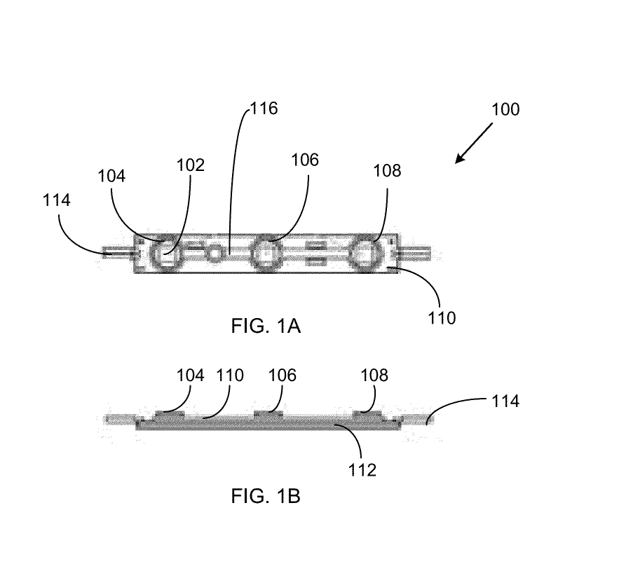

FIGS. 1A and 1B illustrates various views of an exemplary illumination assembly with a flat lens, where FIG. 1A illustrates of a top view, and FIG. 1B illustrates a side view, in accordance with an embodiment of the present invention. In the present embodiment, an illumination assembly 100 may provide variously configured lenses that at least partially deviate the direction of an electromagnetic radiation from an illumination portion 102. The illumination portion may include a light emitting diode for transmitting an electromagnetic radiation though the lenses. The lenses may allow the electromagnetic radiation to pass through, and converge, diverge, and/or remain at a substantially linear angle. In this manner, various optical illusions may be generated through the different angles of electromagnetic radiations. The resulting illumination may project a large viewing angle, a concentrated narrowest beam, and a regular viewing beam.

In one embodiment, the lenses may also serve to help inhibit moisture and contaminants from engaging the illumination portion. A sealing portion may at least partially surround each lens to provide this protection. In one embodiment, the illumination assembly may include three lenses. However, in other embodiments, more or less lenses may be utilized. Suitable materials for the lenses may include, without limitation, glass, transparent polymers, hard resin, and polycarbons. In some embodiments, the assembly may reside in a housing having properties efficacious for absorbing and dispersing thermal energy generated by the light emitting diodes. The housing may further include moisture proof components to protect the light emitting diodes from external contaminants. Suitable materials for the lenses may include, without limitation, glass, thin, flexible polymers, and crystal.

In one embodiment of the present invention, the lenses allow electromagnetic radiations to pass through from the illumination portion. The lenses may include at least one diverging lens 104 that broadens, or diverges the electromagnetic radiation from the illumination portion. The diverging lens may include, without limitation, a concave lens. Additionally, the lenses may include at least one converging lens 106 that focuses, or converges the electromagnetic radiation from the illumination portion. Further, the lenses may include at least one flat lens 108 that allows the electromagnetic radiation to pass through at a substantially straight angle. Each lens may be adjustably angled to orient in a desired direction. In one embodiment, each lens may be angled in various degrees, including, without limitation, 120°, −160°, 180°, 200°, and −240°. Additionally, the illumination portion, sitting in the housing may also have adjustable angles, including, without limitation, 120° and −180°. A wide beam angle may be created in this manner. In this manner, myriad combinations of illumination direction, color, intensity, convergence, and divergence may be projected by the illumination assembly. In some embodiments, the lenses may form a protective cover over the light emitting diodes, protecting them from moisture, weather elements, and physical damage. In some embodiments, the illumination portion may include a light emitting diode. Those skilled in the art, in light of the present teachings, will recognize that light emitting diodes generate a considerable amount of heat.

In one embodiment, a housing 110 may receive and position the light emitting diode and the lenses. The housing may include various shapes, including, without limitation, a circle, an oval, a rectangle, a square, and a triangle. The light emitting diodes may be disposed to orient in a coplanar orientation with the lenses, whereby each lens allows electromagnetic radiations to pass through from an individual light emitting diode. The light emitting diodes may comprise solid state light sources having a long life, and generating an intense source of illumination, whereby excessive thermal energy may be generated. In some embodiments, the housing may include a thermal dispersion portion 112, such as a heat sink, that may be efficacious for dissipating and absorbing the heat generated by the light emitting diodes.

In one embodiment, the housing may include an aluminum board for receiving the illumination portion, and also serves to absorb and disperse heat. The heat sink may position on a peripheral edge of the housing, serving to dissipate thermal energy from the illumination portion to a medium, such as air, between the lens and the housing. In one embodiment, the heat sink may receive thermal energy generated by the illumination portion, and dissipates the thermal energy throughout the housing. A thermally conductive coupling may join the illumination portion to the heat sink for more efficient dissipation of thermal energy generated by the illumination portion. The thermal absorbing portion may comprise an aluminum board that forms a platform for the illumination portion to rest on, and that engages the illumination portion for enhanced dispersion and absorbing of the thermal energy. Suitable materials for the thermal absorbing portion may include, without limitation, ceramic, aluminum alloys, copper, diamond, and copper-tungsten. The heat sink may further include fins or ridges and a fan for enhanced dispersion of the heat.

In one embodiment of the present invention, the lenses may forms a sealed, moisture proof junction with the housing to enhance protection of the illumination portion and the circuitry. A sealing portion 116 may be integrally disposed with the thermal absorbing portion and the lenses to create a moisture proof seal throughout the housing. The sealing portion may include a polyamide melt. However, in other embodiments, the sealing portion may include, without limitation, a rubber seal, caulk, cork, and a polymer sealant. In some embodiments, a circuitry 114 may regulate the actuation of the illumination portion and dispersion of thermal energy. A power source may provide power to the assembly.

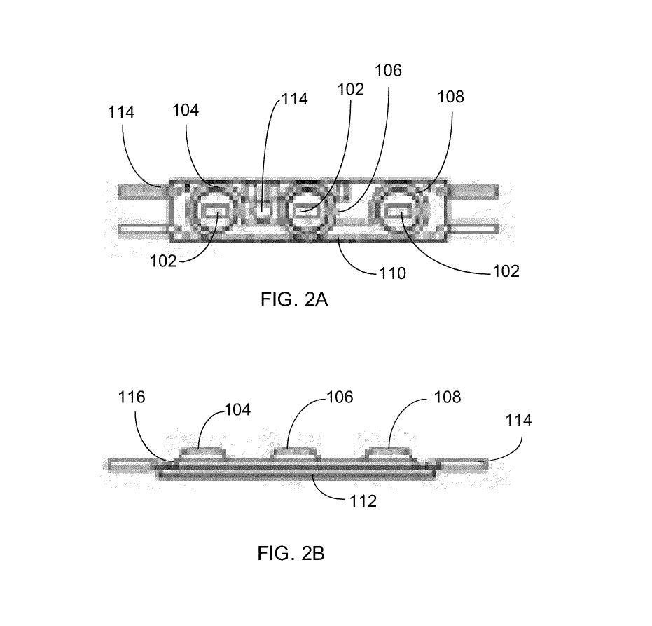

FIGS. 2A and 2B illustrates various views of an exemplary illumination assembly with a converging lens, where FIG. 2A illustrates of a top view, and FIG. 2B illustrates a side view, in accordance with an embodiment of the present invention. In the present embodiment, the illumination portion may employ a plurality of light emitting diodes that position within the housing. In some embodiments, the light emitting diodes may form a pattern in the housing that is efficacious for projecting illumination onto the lenses. Those skilled in the art, in light of the present teachings, will recognize that light emitting diodes present many advantages over incandescent light sources including, without limitation, lower energy consumption, longer lifetime, improved physical robustness, smaller size, and faster switching. The light emitting diode may comprise, various sizes, including, without limitation, 3528, 5050, and 5730 size flexible light emitting diode strips.

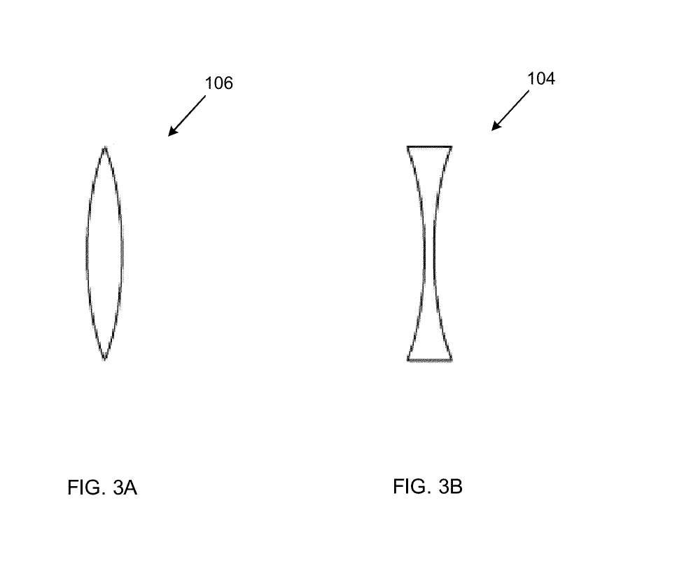

FIGS. 3A and 3B illustrates various views of exemplary lenses, where FIG. 3A illustrates of a converging lens, and FIG. 3B illustrates a diverging view, in accordance with an embodiment of the present invention. In the present embodiment, the lenses may form a protective cover over the light emitting diodes, protecting them from moisture, weather elements, and physical damage. In some embodiments, the illumination portion may include a light emitting diode. Those skilled in the art, in light of the present teachings, will recognize that light emitting diodes generate a considerable amount of heat.

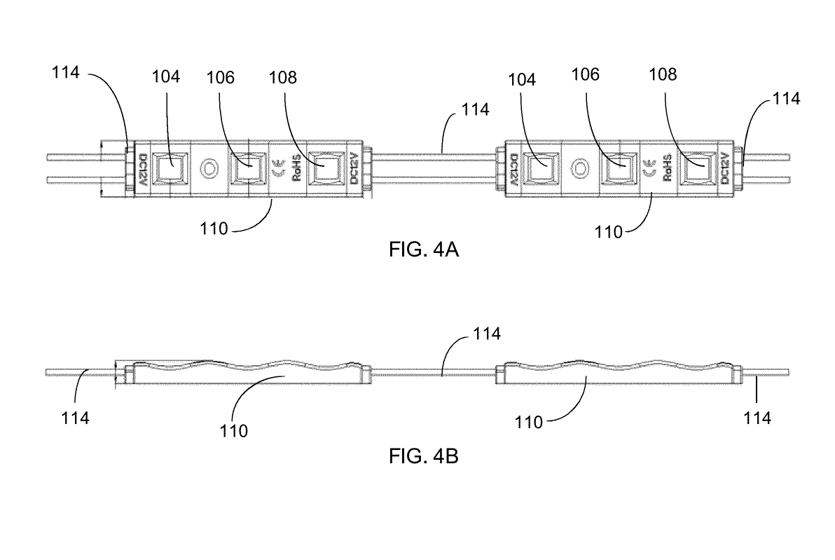

FIGS. 4A and 4B illustrates various views of an exemplary illumination assembly with a flat lens, where FIG. 1A illustrates of a top view of a series of illumination assemblies, and FIG. 1B illustrates a side view of a series of illumination assemblies, in accordance with an embodiment of the present invention. In the present embodiment, a series of illuminating assemblies may string together to form additional illumination projections. In one embodiment, each illumination assembly may be 79 millimeters long and 6.5 millimeters wide. However, in other embodiments, larger or smaller dimensions may be fabricated. Further, the series of assemblies may provide additional length.

In one alternative embodiment, the housing may include a housing interior having a reflective coating that reflects illumination and heat generated by the light emitting diodes. The cumulative effect of heat received from the heat sink and reflective coating allow the assembly to dissipate excess thermal energy. In yet another alternative embodiment, different types of lights could be used with the light emitting diodes, such as fluorescence lights. In yet another alternative embodiment, the lenses may be colored.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing variously configured lenses that reflect electromagnetic radiations into convergence, divergence, and flat illuminations according to the present invention will be apparent to those skilled in the art. Various aspects of the invention have been described above by way of illustration, and the specific embodiments disclosed are not intended to limit the invention to the particular forms disclosed. The particular implementation of the variously configured lenses that reflect electromagnetic radiations into convergence, divergence, and flat illuminations may vary depending upon the particular context or application. By way of example, and not limitation, the variously configured lenses that reflect electromagnetic radiations into convergence, divergence, and flat illuminations described in the foregoing were principally directed to converging, diverging, and flat lenses that regulate the direction of light emitting diodes implementations; however, similar techniques may instead be applied to providing a variety of lights for light shows and entertainment, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An assembly comprising:
a housing, said housing being configured to at least partially encase said assembly;
an illumination portion, said illumination portion being configured to generate and transmit said electromagnetic radiation;
at least one diverging lens, said at least one diverging lens being configured to enable at least partial passage of said electromagnetic radiation, said at least one diverging lens being configured to broaden said electromagnetic radiation;
at least one converging lens, said at least one converging lens being configured to enable at least partial passage of said electromagnetic radiation, said at least one converging lens being configured to focus said electromagnetic radiation; and
at least one flat lens, said at least one flat lens being configured to enable at least partial passage of said electromagnetic radiation, said at least one flat lens being configured to flatten said electromagnetic radiation in a substantially straight angle.

2. The assembly of claim 1, wherein said assembly is configured to provide an illumination display.

3. The assembly of claim 2, wherein said housing is configured to contain said illumination portion, and/or said at least one diverging lens, and/or said at least one converging lens, and/or said at least one flat lens.

4. The assembly of claim 3, wherein said housing positions each lens in a coplanar orientation.

5. The assembly of claim 4, in which said housing comprises a thermal absorbing portion, said thermal absorbing portion being configured to at least partially absorb thermal energy generated by said electromagnetic radiation.

6. The assembly of claim 5, in which said thermal absorbing portion comprises a heat sink.

7. The assembly of claim 6, in which said heat sink comprises an aluminum material.

8. The assembly of claim 7, in which said housing comprises a sealing portion, said sealing portion being integrally disposed with said thermal absorbing portion and each lens to form a moisture proof seal throughout said housing, said sealing portion comprising a polymide melt.

9. The assembly of claim 8, in which said illumination portion comprises light emitting diodes.

10. The assembly of claim 9, in which said illumination portion comprises 3528, and/or 5050, and/or and 5730 sized flexible light emitting diode strips.

11. The assembly of claim 10, wherein said illumination portion is configured to orient at 0 degrees, and/or 120 degrees, and/or 180 degrees.

12. The assembly of claim 11, in which said electromagnetic radiation comprises visible light.

13. The assembly of claim 12, in which said at least one diverging lens comprises a concave lens.

14. The assembly of claim 13, wherein said at least one diverging lens is configured to orient at 0 degrees, and/or 120 degrees, and/or 160 degrees, and/or 180 degrees, and/or 200 degrees, and/or 240 degrees.

15. The assembly of claim 14, in which said at least one converging lens comprises a convex lens.

16. The assembly of claim 15, wherein said at least one converging lens is configured to orient at 0 degrees, and/or 120 degrees, and/or 160 degrees, and/or 180 degrees, and/or 200 degrees, and/or 240 degrees.

17. The assembly of claim 16, wherein said at least one flat lens is configured to orient at 0 degrees, and/or 120 degrees, and/or 160 degrees, and/or 180 degrees, and/or 200 degrees, and/or 240 degrees.

18. The assembly of claim 17, in which said assembly comprises a circuitry, said circuitry being configured to regulate said illumination portion.

19. An assembly comprising:
means for orienting at least one diverging lens, and/or at least one converging lens, and/or at least one flat lens to a desired angle from a housing;
means for orienting an illumination portion to a desired angle from a housing;
means for generating an electromagnetic radiation with said illumination portion;
means for absorbing a thermal energy generated by said illumination portion with a thermal absorbing portion;
means for transmitting said electromagnetic radiation through said at least one diverging lens, and/or said at least one converging lens, and/or said at least one flat lens;
means for broadening said electromagnetic radiation;
means for converging said electromagnetic radiation;
means for allowing said electromagnetic radiation to remain at a substantially straight angle; and
means for forming an illumination display.

20. An assembly consisting of:
a housing, said housing being configured to at least partially encase said assembly, said housing comprising a thermal absorbing portion, said thermal absorbing portion being configured to at least partially absorb thermal energy generated by an electromagnetic radiation, said housing further comprising a sealing portion, said sealing portion being integrally disposed with said thermal absorbing portion and each lens to form a moisture proof seal throughout said housing, said sealing portion comprising a polymide melt;
an illumination portion, said illumination portion being configured to generate and transmit said electromagnetic radiation, said illumination portion comprising light emitting diodes, said light emitting diodes comprising 3528, and/or 5050, and/or and 5730 sized flexible light emitting diode strips, said illumination portion being configured to orient at 0 degrees, and/or 120 degrees, and/or 180 degrees;
at least one diverging lens, said at least one diverging lens being configured to enable at least partial passage of said electromagnetic radiation, said at least one diverging lens being configured to broaden said electromagnetic radiation, said at least one diverging lens comprising a concave lens, said at least one diverging lens being configured to orient at 0 degrees, and/or 120 degrees, and/or 160 degrees, and/or 180 degrees, and/or 200 degrees, and/or 240 degrees;
at least one converging lens, said at least one converging lens being configured to enable at least partial passage of said electromagnetic radiation, said at least one converging lens being configured to focus said electromagnetic radiation, said at least one converging lens comprising a convex lens, said at least one converging lens being configured to orient at 0 degrees, and/or 120 degrees, and/or 160 degrees, and/or 180 degrees, and/or 200 degrees, and/or 240 degrees;
at least one flat lens, said at least one flat lens being configured to enable at least partial passage of said electromagnetic radiation, said at least one flat lens being configured to flatten said electromagnetic radiation in a substantially straight angle, said at least one flat lens being configured to orient at 0 degrees, and/or 120 degrees, and/or 160 degrees, and/or 180 degrees, and/or 200 degrees, and/or 240 degrees; and
a circuitry, said circuitry being configured to regulate said illumination portion.
